(19) United States
(12) Patent Application Publication
(10) Pub. No.: US 2012/0247023 A1
(43) Pub. Date: Oct. 4, 2012

(54) PANEL DOOR AND PANERL USING THE SAME

(75) Inventors: GANG LIU, Shenzhen City (CN); QING-HUI MI, Shenzhen City (CN); HSUAN-TSUNG CHEN, Tu-Cheng (TW); GUANG-YAO LEE, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/216,184

(22) Filed: Aug. 23, 2011

(30) Foreign Application Priority Data
Apr. 1, 2011 (CN) 201110081549.4

(51) Int. Cl. E06B 3/70; E05B 65/06; E05B 65/00

(52) U.S. Cl. 49/386; 49/503

(57) ABSTRACT

A panel includes a base plate, a door, a locking member, and a button. The base plate has an opening defined therein. The door engages with the base plate to cover the opening, wherein a hook extending from the door to pass through the opening. The locking member is installed in an inner side of the base plate, wherein a block section is arranged on the locking member to block the hook. The button is installed to the base plate, and a press member of the button extends through a first passage of the base plate when the button is depressed, so the press member presses against the locking member to release the hook from the block section. The panel includes a resilient member; the two ends of the resilient member are installed on the base plate and the locking member to rotate the locking member to block the hook by the block section.

### BACKGROUND

1. Technical Field

The present disclosure relates to a door, and particularly, to a panel door.

2. Description of Related Art

For installing or removing hardware inside a computer, a removable cover which is usually screwed to a front panel of the computer must be removed in order to access the hardware. However, it's inconvenient to loosen and tighten screws to remove the cover.

Therefore, what is needed is a panel door which can be opened and closed easily.

### BRIEF DESCRIPTION OF THE DRAWINGS

The components in the drawings are not necessarily drawn to scale, the emphasis instead being placed upon clearly illustrating the principles of a panel door. Moreover, in the drawings, like reference numerals designate corresponding parts throughout the several views.

FIG. 1 is an isometric, exploded view of an exemplary embodiment of a panel.

FIG. 2 is a view similar to FIG. 1, but showing another aspect of the panel.

FIG. 3 is an enlarged view of a locking member of FIG. 2.

FIG. 4 is an assembled, rear view of the panel of FIG. 1, showing the locking member in a locked position.

FIG. 5 is a rear view of the panel of FIG. 1, showing the locking member in a unlocked position.

FIG. 6 is an isometric view of the panel of FIG. 1, showing a door is open.

### DETAILED DESCRIPTION

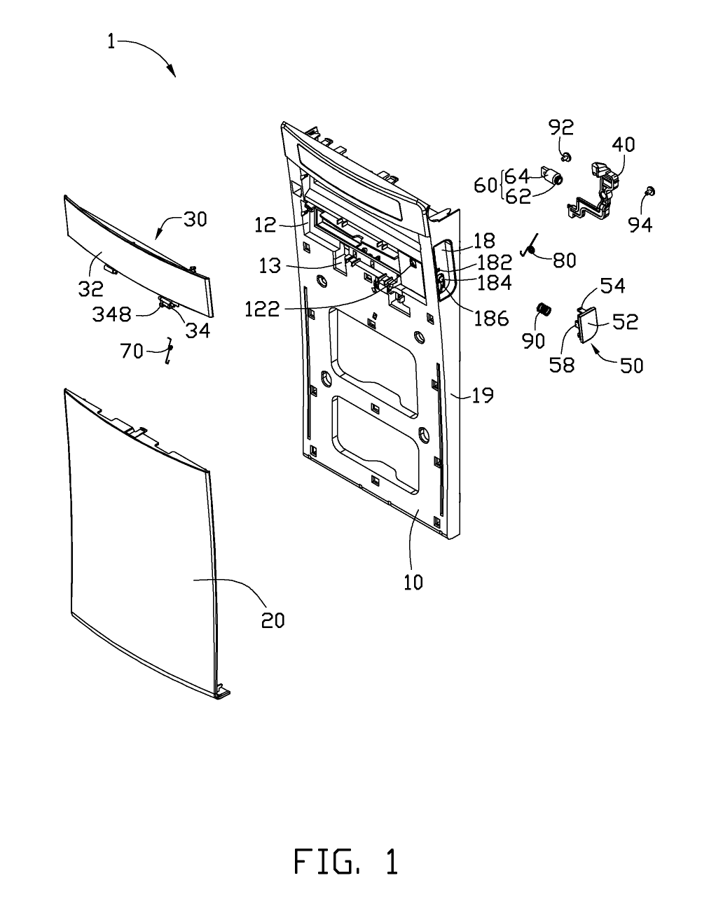

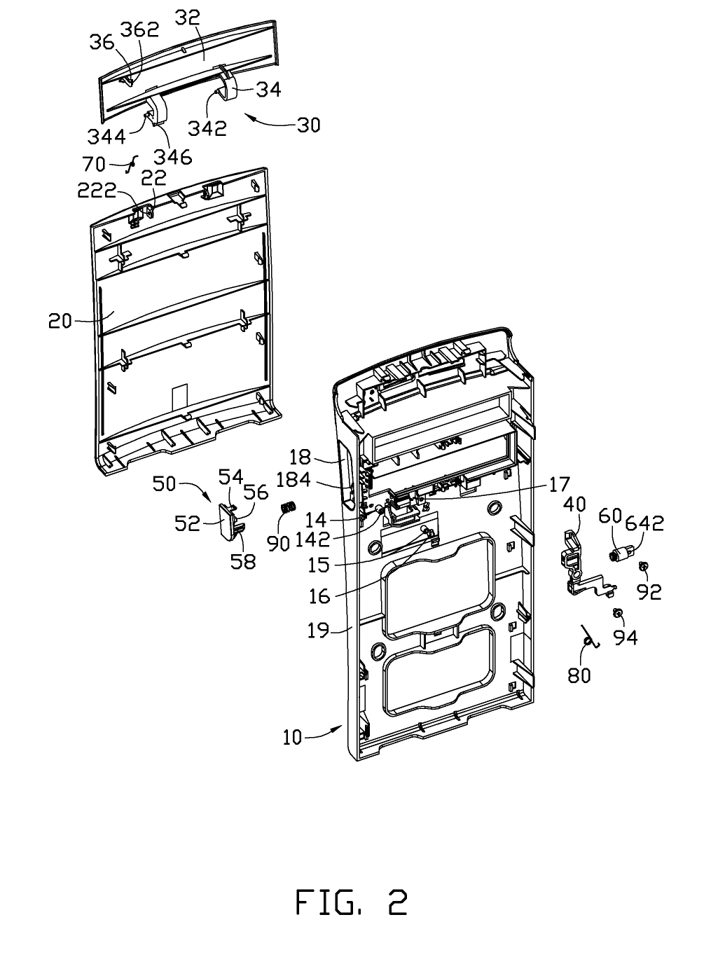

Referring to FIG. 1-2, a panel 1 includes a base plate 10, a front plate 20, a door 30, a locking member 40, a button 50, a gear complex 60, and three resilient members 70, 80, and 90.

An opening 12, corresponding to the door 30, is defined on the base plate 10, and a first passage 122 is defined on the base plate 10 in adjacent to the opening 12. Two chambers 13 are defined on the front of the base plate 10, and a fixation post 14, a second resilient member holder 15, a retaining clamp 16, and a first mounting hole 17 are arranged on the back of the base plate 10. Two side panels 19 extend from the base panel inwardly, and a recess 18 is defined on the side panel 19 to receive the button 50. Two securing holes 182 are defined in the recess 18 to retain the button 50, and a first pillar 184 and a second passage 186 are defined between the two securing holes 182.

Two tabs 22 having two bores 222 respectively are arranged on the top of the front plate 20. The door 30 includes a door plate 32, two C-shaped pivot sections 34 arranged in the bottom of the door plate 32, and a hook 36 arranged in the top of the door plate 32. Two axles 342 are arranged in an inner side of the two pivot sections 34, respectively, and a first resilient member holder 344 is arranged in an outer side of one of the two pivot sections 34. A retaining section 346 and a fan-shaped toothed part 348 are arranged in the bottom of the pivot section 34. A pushing bevel 362 is defined on the hook 36.

The button 50 includes a button plate 52, two securing pins 54, a second pillar 56, and a press member 58. The two securing pins 54 extended from the button plate 52 to engage with the securing holes 182 of the recess 18 to secure the button 50 to the recess 18. The third resilient member 90 is penetrated by the first pillar 184 and the second pillar 56 when the button 50 is installed into the recess 18 and the press member 58 can be pushed into the base plate 10 through the passage 186 when the button is depressed.

The gear complex 60 includes a gear base 64, a gear 62, and a second mounting hole 642. The gear 62 is pivotally mounted to the gear base 64 to mesh with the teeth of the toothed part 348 of the door 30. The second mounting hole 642 defined on the gear base 60 corresponds to the first mounting hole 17 of the base plate 10.

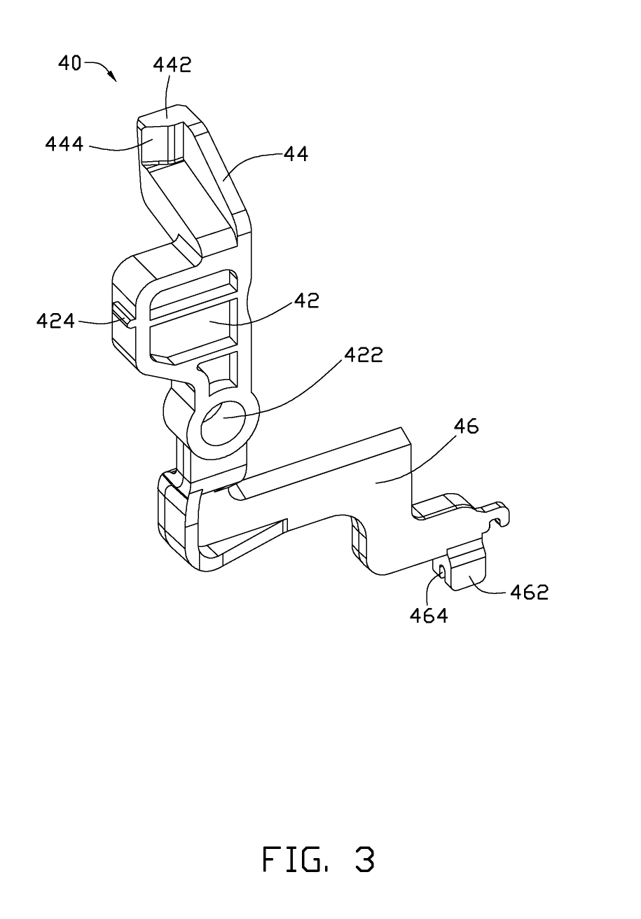

Referring to FIG. 3, the locking member 40 includes a arm 42, an L-shaped actuating arm 46 perpendicular to the arm 42. A pivot hole 422 corresponding to the fixation post 14 is defined on the arm 42, and a ridge 424 is arranged on one side of the arm 42. A block section 44 extends from the arm 42 perpendicular to the arm 42 and the actuating arm 46. A retaining part 442 having a block surface 444 is formed on the block section 44. An actuating section 462 having a trough 464 is formed on the actuating arm 46.

When assembling the front plate 20 and the door 30, the bore 222 of the tab 22 is pivotally engaged on the axle 342 of the pivot section 34. The first resilient member 70 is attached to the first resilient member holder 344 of the pivot section 34. When assembling the front plate 20 and the door 30 to the base plate 10, the two tabs 22 and the two pivot sections 34 are received in the two chambers 13 of the base plate 10. The toothed part 348 of the door 30 is exposed to the inner side of the base plate 10. The two ends of the first resilient member 70 are pressed against the base plate 10 and the door 30 to force the door 30 open.

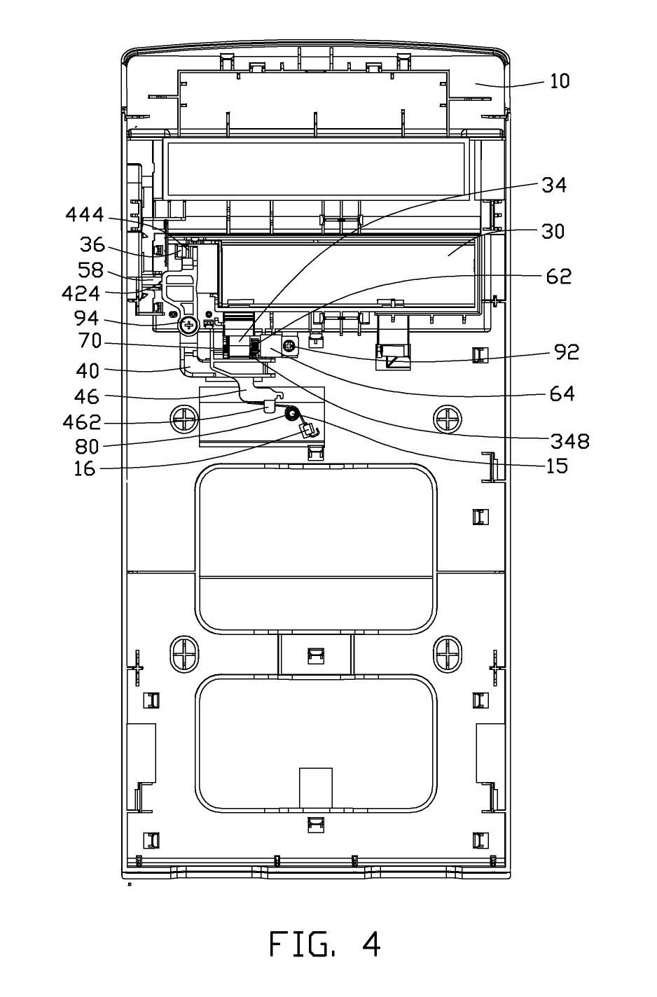

Referring to FIG. 4, the gear complex 60 is mounted to the base plate 10 by a first screw 92 penetrating through the second mounting hole 642 of the gear base 64 and mounted to the first mounting hole 17 of the base plate 10. The gear 62 is meshed to the toothed part 348 of the door 30 to control the rotation speed of the pivot section 34.

The locking member 40 is pivotally mounted to the back of the base plate 10 by the fixation post 14, and a second screw 94 penetrates through the pivot hole 422 and is mounted to a fixation hole 142 of the fixation post 14. The second resilient member 80 is set in the second resilient member holder 15 of the base plate 10, and the two ends of the second resilient member 80 are pressed against the retaining clamp 16 of the base plate 10 and the trough 464 of the actuating section 462 of the locking member 40. The second resilient member 80 pushes the locking member 40 around and forces the block section 44 to move toward the first passage 122 of the base plate 10. The ridge 424 of the arm 42 presses against the press member 58 of the button 50.

Rotating the door 30 toward the base plate 10 allows the hook 36 of the door 30 to pass through the first passage 122 and press against the retaining part 442 of the block section 44 with the pushing bevel 362 to force the locking member 40 to rotate, and the resilient member deforms elastically. When the pressure on the door 30 toward the base plate 10 is continuous, the pushing bevel 362 slides through the retaining part 442 and the hook 36 is engaged with the block surface 444; the resilient member forces the locking member 40 to rotate and blocks the hook 36 with the block surface 444, and the door 30 remains closed.

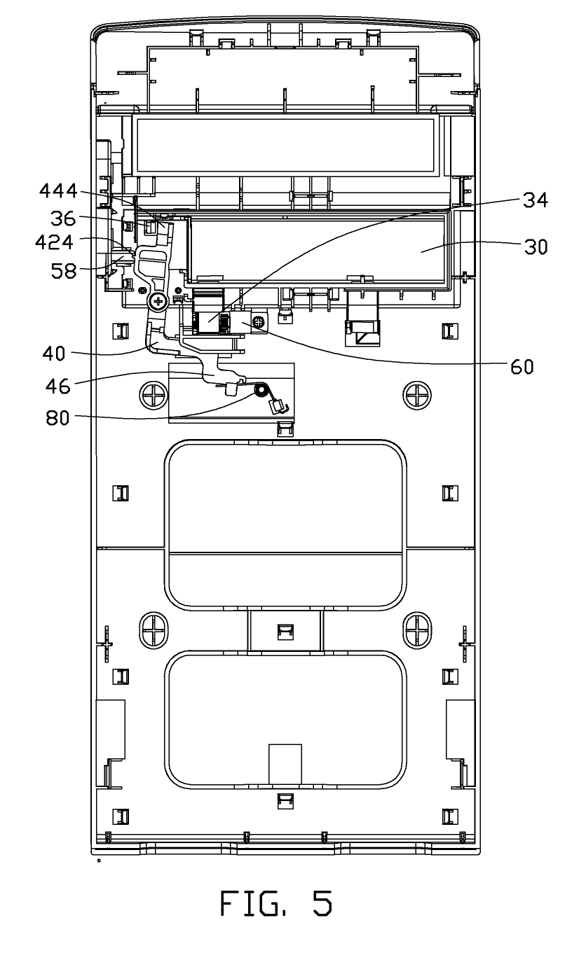

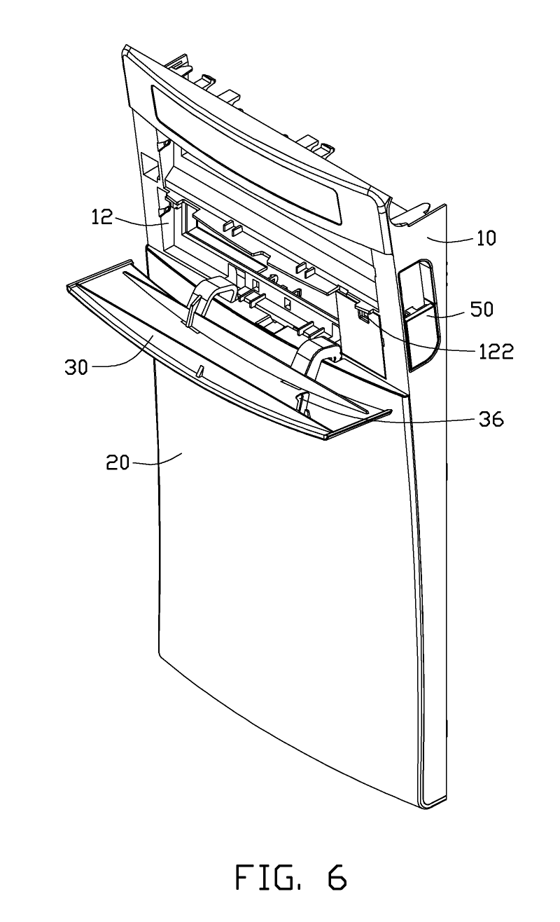

Referring to FIG. 5-6, when trying to open the door 30, a push on the button plate 52 of the button 50 forces the press member 58 to press against the arm 42 to rotate the locking member 40. The retaining part 442 releases the hook 36 when the locking member 40 rotates, and the first resilient member 70 forces the door 30 to open, until the retaining section 346 of the door 30 is blocked by the base plate 10, controlling the angle between the door 30 and the base plate 10. The gear 62 is a damping gear that buffers and slows the rotation of the door 30, to avoid a collision with the base plate 10 and for noise-reduction. The door 30 remains open when the button 50 is released, and the second resilient member 80 forces the locking member 40 to rotate to its initial position.

In other embodiments, the first resilient member 70 as well as the tab 22 can be arranged on the base plate 10 to install the door 30 on the base plate 10.

Therefore, the door 30 can be opened by pressing the button 50, and closed when pushed back to the base plate 10.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A panel, comprising:
a base plate defining an opening therein;
a door engaged with the base plate to cover the opening, wherein a hook extending from the door to pass through the opening;
a locking member installed in an inner side of the base plate, wherein a block section is arranged on the locking member to block the hook; and
a button installed to the base plate, wherein a press member of the button extends through a first passage of the base plate when the button is depressed, and presses against the locking member to release the hook from the block section.

2. The panel as claimed in claim 1, wherein the panel comprises a resilient member; two ends of the resilient member are installed to the base plate and the locking member to rotate the locking member to block the hook by the block section.

3. The panel as claimed in claim 2, wherein the resilient member is a torsion spring; two ends of the resilient member presses against an actuating section of the locking member and a retaining clamp of the base plate.

4. The panel as claimed in claim 3, wherein a trough is defined in the actuating section, and one of the two ends of the resilient member engages and presses against the trough.

5. The panel as claimed in claim 1, wherein a pivot section is arranged on the door.

6. The panel as claimed in claim 5, wherein the pivot section is pivotally mounted to the base plate; two ends of a resilient member presses against the base plate and the door.

7. The panel as claimed in claim 6, wherein a gear complex is mounted to the base plate; the gear complex comprises a gear meshing with a toothed part of the door.

8. The panel as claimed in claim 7, wherein the gear is a damping gear.

9. The panel as claimed in claim 5, wherein the panel comprises a front plate mounted on an outer side of the base plate.

10. The panel as claimed in claim 9, wherein a pivot section is pivotally mounted to the front plate; two ends of a resilient member presses against the base plate and the door.

11. The panel as claimed in claim 10, wherein an axle arranged on the pivot section is pivotally engaged to a tab of the front plate.

12. The panel as claimed in claim 11, wherein a chamber is defined on the base plate to receive the pivot section and the tab.

13. The panel as claimed in claim 1, wherein a recess is defined on the base plate to receive the button; a second passage is defined in the recess to allow the press member to penetrate through the base plate.

14. The panel as claimed in claim 13, wherein a securing hole is defined in the recess to engage with a securing pin extended form the button.

15. The panel as claimed in claim 14, wherein a first pillar is defined in the recess; a second pillar is arranged on the button; a resilient member is set between the first pillar and the second pillar.

16. The panel as claimed in claim 1, wherein a pushing bevel is arranged on the hook to push a retaining part of the block section; the locking member rotates and the hook is blocked by a block surface of the retaining part after the pushing bevel slides through the retaining part.
